(19) United States
(12) Patent Application Publication
(10) Pub. No.: US 2005/0254227 A1
(43) Pub. Date: Nov. 17, 2005

(54) Chemiluminescent light article

(76) Inventor: Wayne Louis Bilodeau, Mentor, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/126,440

(22) Filed: May 11, 2005

Related U.S. Application Data
(60) Provisional application No. 60/570,580, filed on May 13, 2004.

(51) Int. Cl. F21K 2/06

(52) U.S. Cl. 362/34; 362/266

(57) ABSTRACT

The invention provides a chemiluminescent light emitting article having a transparent facestock layer, a chemiluminescent layer comprising at least one chemiluminescent compound and a latent initiator, and an activator layer comprising at least one activating compound operable to react with the latent initiator whereby the initiator causes the chemiluminescent compound to emit light.

This application claims the benefit of provisional application Ser. No. 60/570,580 filed on May 13, 2004, which is hereby incorporated herein by reference in its entirety.

### TECHNICAL FIELD OF THE INVENTION

The present invention relates generally to a chemiluminescent light device. In particular, the invention relates to a multi-component tape or sheet for producing chemiluminescent light.

### BACKGROUND OF THE INVENTION

Articles that produce light in response to the mixing of two reactive liquids have been utilized as safety devices and as novelty items. The principle and the techniques for the production of chemiluminescent light are described in U.S. Pat. No. 4,678,608, which is incorporated herein by reference. The chemiluminescence is produced by reaction in the liquid phase of an activator such as hydrogen peroxide with a chemiluminescent, such as an oxalate. Other secondary compounds, such as fluorescent agents, may also be present. Generally, fluorescent agents modify the characteristics of the emitted chemically produced light.

Some chemiluminescent articles include one of the two liquids in a glass tube capable of breaking and of thus expanding its contents into a chamber already equipped with the second liquid. More recently, commercially available chemiluminescent articles can have two distinct chambers, each made of a translucent flexible material. These articles have the advantage of avoiding the use of glass as the frangible inner tube.

Sheets having reflective and retroreflective materials are used to offer night visibility of items bearing the reflective or retroreflective sheets. It is sometimes desirable to use luminous materials in conjunction with the reflective or retroreflective sheets to provide increased nighttime visibility in locations having little ambient light. A luminous material is a material having a phosphorescent or fluorescent property. A phosphorescent or fluorescent property includes the ability to absorb energy from impinging light and to reemit the absorbed energy as light. Examples of luminous devices are shown in U.S. Pat. No. 1,373,783, which discloses a glass plate mounted in a metal holder and a layer of luminous powder compressed between the glass plate and the metal holder; U.S. Pat. No. 2,333,641, which discloses a luminous adhesive sheet or tape material; and U.S. Pat. No. 5,415,911, which discloses a photoluminescent and retroreflective sheet material, the disclosures of which are incorporated herein by reference.

The chemiluminescent articles that mix liquids do not have a mechanism for subsequently unmixing the liquids. Thus, the reaction continues until one of the reactants is exhausted. The need for the reactant liquids to be maintained in separate chambers limits the configurations available for the chemiluminescent articles to those having such separate chambers and a means for combining the reactant liquids. Reflective or retroreflective sheets require an external light source for their utility to be realized.

It would be desirable to have a chemiluminescent article having improved properties. Such a chemiluminescent article may include a mechanism for controlling the reaction of the reactants, a different configuration that does not, for example, include separate chambers for storing liquid reactants, but does include an integral source of energy to create, for example, a luminescent, chemiluminescent and/or fluorescent light.

### SUMMARY OF THE INVENTION

The present invention provides a chemiluminescent light emitting article. In a first aspect of the invention, the chemiluminescent article comprises a transparent facestock layer having an inner surface and an outer surface; a chemiluminescent layer comprising at least one chemiluminescent compound and a latent initiator, wherein the inner surface of the facestock layer overlies the chemiluminescent layer; and an activator layer comprising at least one activating compound operable to react with the latent initiator whereby the initiator causes the chemiluminescent compound to emit light.

The facestock layer, in one embodiment, is capable of being folded onto itself to bring the activator layer into contact with the chemiluminescent layer. The chemiluminescent layer and/or the activator layer may comprise an adhesive layer.

In one embodiment, the article includes a release liner that has a release surface and a second surface to which the activator layer is adhered. The release surface of the release liner is initially adhered to the chemiluminescent layer. To activate the chemiluminescent layer, the release liner is removed from the chemiluminescent layer and repositioned so that the activator layer is in contact with the chemiluminescent layer.

### BRIEF DESCRIPTION OF THE DRAWINGS

FIGS. 1a and 1b are cross-sectional views of an embodiment of a chemiluminescent article according to the present invention.

FIGS. 2a and 2b are cross-sectional views of another embodiment of a chemiluminescent article according to the present invention.

### DESCRIPTION OF THE INVENTION

The term “overlies” and cognate terms such as overlying and the like, when referring to the relationship of one or a first layer relative to another or a second layer, refers to the fact that the first layer partially or completely overlies the second layer. The first layer overlying the second layer may or may not be in contact with the second layer. For example, one or more additional layers may be positioned between the first and the second layer. The term “underlies” and cognate terms such as “underlying” and the like have similar meanings except that the first layer partially or completely lies under, rather than over the second layer.

A chemiluminescent article of a first embodiment comprises a polymeric facestock having an upper and a lower surface, wherein the facestock is at least partially transmissive to light; a chemiluminescent layer comprising a chemiluminescent compound and having an upper surface and a lower surface; and an activator layer having an upper surface and a lower surface, wherein the lower surface of both the activator layer and the chemiluminescent layer overlies the upper surface of the facestock layer.

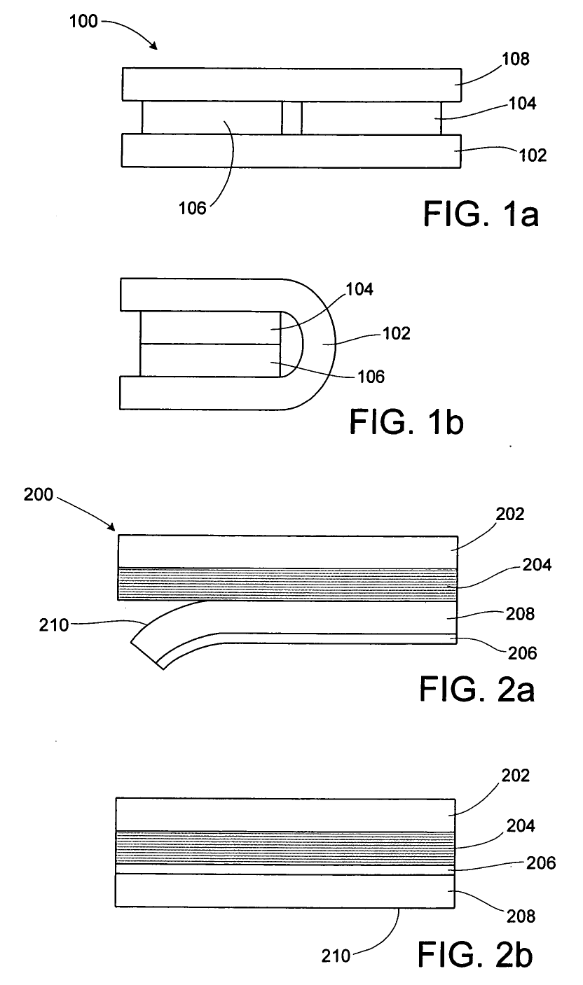

The chemiluminescent article of the first embodiment is illustrated in FIGS. 1a and 1b. The article may be a tape, or may be in sheet form. Article 100 comprises polymeric facestock 102, chemiluminescent layer 104 on the upper surface of facestock 102, and activating layer 106 also on the upper surface of facestock 102. The article may optionally include a removable release liner 108 overlying the upper surfaces of chemiluminescent layer 104 and activating layer 106.

In order to activate the chemiluminescent article so that the chemiluminescent layer 104 emits light, as illustrated in FIG. 1b, release liner 108, if present, is removed and the facestock 102 is folded over onto itself to contact the chemiluminescent layer 104 with the activating layer 106. In one embodiment, the activating layer comprises a hydrogen peroxide compound and the chemiluminescent layer comprises a chemiluminescent compound. In another embodiment, the activating layer comprises a transitional metal compound and the chemiluminescent layer comprises a chemiluminescent compound in combination with a latent peroxy compound. The latent peroxy compound is capable of generating hydrogen peroxide when contacted with the transition metal compound of the activating layer.

In a second embodiment, illustrated in FIGS. 2a and 2b, chemiluminescent article 200 includes facestock layer 202 overlying chemiluminescent layer 204. Release liner 208 is releasably adhered to the chemiluminescent layer 204. Release liner 208 has a release surface 210 and an activating layer 206 on the surface opposite the release surface 210.

To activate the chemiluminescent article 220 so that the chemiluminescent layer 204 emits light, as illustrated in FIG. 2b, release liner 208 is removed and re-adhered to chemiluminescent layer 204 with activating layer 206 in contact with chemiluminescent layer 204. In one embodiment, release liner 208 is a double-sided release liner and can be completely removed from the chemiluminescent article, leaving activating layer 206 adhered to chemiluminescent layer 204.

The chemiluminescent layer (104 and 204) comprises at least one chemiluminescent compound and may also include a fluorescer compound. The chemiluminescent layer comprises a film-forming material. In one embodiment, the chemiluminescent layer comprises an adhesive layer. The adhesive layer may be a pressure sensitive adhesive. In another embodiment, the chemiluminescent layer comprises a gel layer.

In one embodiment (not illustrated) the chemiluminescent layer 104, 204 comprises at least one chemiluminescent compound, and the activating layer 106, 206 comprises an oxidizer that, when in contact with the chemiluminescent layer, causes the chemiluminescent layer to emit light. The oxidizer may or may not be a latent oxidizer. If a latent oxidizer is used, the chemiluminescent layer may comprise a transition metal compound to switch the latent oxidizer to an active oxidizer on contact.

Chemiluminescent compounds useful in the present invention include luminol (3-aminophthalhydrazide) and oxalates such as bis(2,6-dichloro-4-nitrophenyl) oxalate, bis(2,4,6-trichlorophenyl) oxalate, bis(3-trifluoromethyl4-nitrophenyl) oxalate, bis(2-methyl-4,6-dinitrophenyl) oxalate, bis(1,2-dimethyl-4,6-dinitrophenyl) oxalate, bis(2,4-dichlorophenyl) oxalate, bis(2,5-dinitrophenyl) oxalate, bis(2-formyl-4-nitrophenyl) oxalate, bis(pentachlorophenyl) oxalate, bis)1,2-dihydro-2-oxo-1-pyridyl) glyoxal, bis-N-phthalmidyl oxalate, bis(2,4,5-trichloro-6-carbopentoxyphenyl) oxalate, bis(2,4,5-trichloro-6-carbobutoxyphenyl) oxalate, bis(2,4,6-trichlorophenyl) oxalate, bis(2,4,5-trichloro-6-carbopentoxyphenyl) oxalate, bis(2,4,5-trichloro-6-carbobutoxyphenyl) oxalate and bis(2,4,6-trichlorophenyl) oxalate.

Useful chemiluminescent compounds include those disclosed in U.S. Pat. No. 6,002,000, which is incorporated herein by reference. Specifically, compounds having the formula: 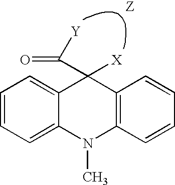
wherein: X is O or S and Y is N, Z is a chain 2 carbon atoms in length, the chain being part of a fused benzene ring; wherein 0 to 8 hydrogens of the compound may be replaced by a W where each W is independently alkyl alklidine, aryl, aralkyl, or an alkyl, aryl, or aralkyl substituted with one or more radicals or functional groups, wherein the functional groups are independently selected from carboxylic acids, alcohols, thiols, carboxamides, carbamates, carboxylic acid esters, phosphoramides, sulfonamides, ethers, sulfides thioesters, olefins, acetylenes, amines, ketones, aldehydes, nitriles and halogens.

The chemiluminescent compound may also comprise the oxalates disclosed in U.S. Pat. No. 6,126,871, which is hereby incorporated by reference. Specifically, these oxalates include those having the formula: 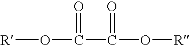
wherein R′ and R″ are one or different members selected from:
I. Aryl groups: e.g., phenyl-, naphthyl-, and substituted aryl, typical substituents being: halo, such as, chloro, bromo or iodo; acyloxy, such as, benzoyloxy; carbonyl, such as, formyl or acetyl; and carboxyl, such as, carboxy, sulfo;
II. Heterocyclic groups: e.g., pyridyl-, acridinyl-, and substituted heterocyclic groups, typical substituents being: alkyl, such as, methyl, ethyl or octyl; halo, such as, chloro, bromo or iodo; acyloxy, such as acetoxy carbonyl such as formyl; carboxyl such as carboxy; alkoxy, such as, methoxy; amino, such as, triethylammonium; and, sulfo;
III. Unsaturated alkyl groups: e.g., vinyl-, ethynyl-, cyclo-, hexenyl-, isopropenyl-, and substituted derivatives thereof, typical substituents being halo, phenyl, cyano, carboxy groups, and the like;
IV. Electronegatively substituted groups: e.g., 1,1,1,3,3,3,-hexafluoro-2-propyl-,1,1,1,3,3,3,-hexachloro-2-cyano-2-propyl-, perfluoro-t-butyl-, dicyanomethyl-, trimethyl-, ammonium-methyl-.

Among these oxalates are, for example: bis (2-carbalkoxy-3,4,6-trichlorophenyl) oxalate, e.g., the 2-carbobutoxy and 2-carbopentoxy compounds, bis (3-carbalkoxy-2,4,6-trichlorophenyl) oxalate, bis(4-carbalkoxy-2,3,6-trichlorophenyl)oxalate, bis(3,5-dicarbalkoxy-2,4,6-trichlorophenyl oxalate. Bis(2,3-dicarbalkoxy-4,5,6 trichlorophenyl)oxalate, bis (2,4-dicarbalkoxy-3,5,6-trichlorophenyl) oxalate, bis (2,5-dicarbalkoxy-3,4,6-trichlorophenyl)oxalate, bis(2,6-dicarbalkoxy-3,4,5-trichlorophenyl) oxalate, bis(3-carbalkoxy-2,4,5,6-tetrachlorophenyl)oxalate, bis (2-carbalkoxy-3,4,5,6-tetrachlorophenyl)oxalate, bis(4-carbalkoxy-2,3,5,6-tetrachlorophenyl) oxalate, bis(6-carbalkoxy-2,3,4-trichlorophenyl) oxalate, bis(2,3,-dicarbalkoxy-4,6-dichlorophenyl) oxalate, bis(3,6-dicarbalkoxy-2,4-dichlorophenyl) oxalate, bis(2,3,5-tricarbalkoxy-4,6-dichlorophenyl) oxalate, bis(3,4,5-tricarbal koxy-2,6-dichlorophenyl) oxalate, bis(2,4,6-tricarbalkoxy-3,5-dichlorophenyl) oxalate, bis(3-bromo-6-carbohexoxy-2,4,5-trichlorophenyl) oxalate, bis(bis(3-bromo-2-carbethoxy-4,6-dichlorophenyl) oxalate, bis(2-carbethoxy4,6-dichloro-3-nitrophenyl) oxalate, bis {2-carbomethoxy-4,6-dichloro-3-(trifluoromethyl)phenyl} oxalate, bis(2-carbobutoxy-4,6-dichloro-3-cyanophenyl) oxalate, bis(2-carboctyloxy-4,5,6-trichloro-3-ethoxyphenyl) oxalate, bis(2-carbobutoxy-3,4,6-trichloro-5-ethoxphenyl) oxalate, bis(2-carbisopropoxy-3,4,6-trichloro-5-methylphenyl) oxalate, bis(2-carbisopropoxy-4,6-dichloro-5 octylphenyl) oxalate, bis[2-carbomethoxy-3,5,6-trichloro-4-(1,1,3,3-tetramethylbutyl)-phenyl] oxalate, bis{2-[carbobis(trifluoromethyl) methoxy]-3,4,5,6-tetrafluorophenyl} oxalate, bis(3,4,6-tribromo-2-carbocyclohexoxyphenyl) oxalate, bis(2,4,5-tribromo-6-carbophenoxy-3-hexadecylphenyl) oxalate, bis(2,4,5-trichloro-6-carbobutoxyphenyl)oxalate and bis (2,4,5-trichloro-6-carbopentoxyphenyl) oxalate.

Fluorescers may be included in the chemiluminescent layer to allow the wavelength of the emitted light to be shifted. Fluorescers include, but are not limited to, coumarins such as ambelliferone; xanthenes such as florescene and rhodamine; squarates; substituted anthracenes such as 9,10-bis-(phenylethynyl) anthracene, 1-methyl-9,10-bis--(phenylethynyl) anthracene, 1-chloro-9,1-bis--(phenylethynyl) anthracene, 9,10-bis(4-methoxyphenyl)-2-chloroanthacene, and 9,10-bis( 4-ethoxyphenyl)-2-chloroanthacene; 16,17-didecycloxyviolanthrone, LUMOGEN RED™ (a red-emitting perylene dicarboximide fluorescer), LUMOGEN YELLOW™ (a yellow-emitting perylene dicarboximide fluorescer), LUMOGEN ORANGE™ (an orange-emitting perylene dicarboximide fluorescer), 5,12-bis-(phenylethynyl) napthacene, 5,16,11,12-tetraphenylnapthacene, and combinations thereof.

In one embodiment, the latent initiator may be a quiescent oxidizer that after activation by the activator and contact with the chemiluminescent compound, cause the chemiluminescent compound to emit light or to glow. That is, the initiator may be initially in a latent form or state and not substantially reactive with the chemiluminescent. However, the latent initiator may respond to the presence of the activator by switching from the latent form to a non-latent state or active form. In the active form, the initiator reacts with the chemiluminescent compound to produce light or to glow. The latent form may be chemically blocked, and the initiator chemically unblocks the activator.

In one embodiment, the activator comprises a latent peroxide, and in one embodiment, the peroxide may be hydrogen peroxide. While, the hydrogen peroxide and the chemiluminescent compound may be principle players in the chemical oxidation reaction producing light, a catalyst will accelerate the process and produce a relatively brighter glow. A suitable oxidizer may be hydrogen peroxide; other suitable oxidizers include perborate, permanganate, hypochlorite, iodine, combinations thereof, and the like.

The peroxy initiators useful in the present invention include hydroperoxides such as organic hydroperoxides and organic peresters. The general class of common hydroperoxides can be represented by the formula R(OOH)_{z}, wherein R generally is a hydrocarbon group containing up to about 18 carbon atoms, and z is 1, 2 or 3. In one embodiment, z is 1 and R is a an alkyl, aryl or aralyl hydrocarbon group containing from about 3 to about 12 carbon atoms. Examples of peresters include t-butylperacetate, t-butyl peroxyisoburyrate; di-t-butyl diperphthalate, t-butyl berbenzoate, 2,5-dimethyl-2,5-bis(benzoylperoxy) hexane, t-butyl peroxymaleic acid and combinations thereof.

In one embodiment, the chemiluminescent layer may comprise an adhesive layer containing at least one chemiluminescent compound. Useful adhesives include synthetic rubber-based adhesives, natural rubber-based adhesives, vinyl ether adhesive, acrylate adhesive, methacrylate adhesive, urethane adhesive, epoxy-based adhesive, silicone adhesives, and mixtures thereof. The acrylate adhesive may be, for example, a tri-functional acrylate monomer based on a glycerol derivative. Also included are pressure sensitive adhesive materials described in Adhesion and Bonding, Encyclopedia of Polymer Science and Engineering, Vol. 1, pages 476-546, Interscience Publishers, 2nd Ed. 1985, the relevant disclosure of which is hereby incorporated by reference.

Some of the above-referenced suitable pressure sensitive adhesive materials may contain as a major constituent resin-based material such as acrylic type polymers, block copolymers, natural, reclaimed or styrene butadiene rubbers, tackified natural or synthetic rubbers, random copolymers of ethylene and vinyl acetate, ethylene-vinyl-acrylic terpolymers, polyisobutylene, poly(vinyl ether), and the like.

Suitable silicone-based pressure sensitive adhesives may include two components, a base polymer and a tackifying resin. The polymer can be a high molecular weight polydimethylsiloxane or polydimethyldiphenylsiloxane containing a terminal silanol group (SiOH), or a block copolymer that includes polydiorganosiloxane soft segments and urea terminated hard segments. The tackifying resin may be a silicate endcapped with trimethylsiloxy groups (OSiMe₃) and which contains a silanol group. Commercially available tackifying resins include SR 545 from General Electric Co., Silicone Resins Division (Waterford, N.Y.) and MQD-32-2 from Shin-Etsu Silicones of America, Inc. (Torrance, Calif.).

The polymer facestock layer (102, 202) may be a monolayer film or a multilayer film. The multilayer film may comprise from two to ten or more layers. The polymer facestock may be oriented or not oriented. The polymer facestock is at least partially transmissive to the light generated by the chemiluminescent layer. In one embodiment, the facestock comprises an optically clear or transparent layer.

A wide variety of polymer film materials are useful in preparing the facestocks of the present invention. For example, the polymer film material may include polymers and copolymers such as at least one polyolefin, polyacrylate, polystyrene, polyamide, polyvinyl alcohol, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, cellulosics, polyacrylonitrile, alkylene-vinyl acetate copolymer, or mixtures of two or more thereof.

The polyolefins which can be utilized as the polymer film material include polymers and copolymers of olefin monomers containing 2 to about 12 carbon atoms such as ethylene, propylene, 1-butene, etc., or blends of mixtures of such polymers and copolymers. In one embodiment the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer also are useful. In another embodiment, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content. Useful propylene homopolymers and copolymers are described in U.S. Pat. No. 5,709,937 (Adams et al). The copolymers include propylene-ethylene copolymers containing up to about 10% by weight of ethylene, and propylene-1-butene copolymers containing up to about 15% by weight of 1-butene. Oriented films described in the '937 patent are clear films useful as the facestock in the labels of the present invention. The disclosure of U.S. Pat. No. 5,709,937 is hereby incorporated by reference.

Various polyethylenes can be utilized as the polymer film material including low, medium, and high density polyethylenes, and mixtures thereof. An example of a useful low density polyethylene (LDPE) is Rexene 1017 available from Huntsman. An example of a useful high density polyethylene (HDPE) is Formoline LH5206 available from Formosa Plastics. In one embodiment the polymer film material comprises a blend of 80 to 90% HDPE and 10-20% of LDPE.

The propylene homopolymers which can be utilized as the polymer film material in the invention, either alone, or in combination with a propylene copolymer as described herein, include a variety of propylene homopolymers such as those having melt flow rates (MFR) from about 0.5 to about 20 as determined by ASTM Test D 1238. In one embodiment, propylene homopolymers having MFRs of less than 10, and more often from about 4 to about 10 are particularly useful. Useful propylene homopolymers also may be characterized as having densities in the range of from about 0.88 to about 0.92 g/cm³. A number of useful propylene homopolymers are available commercially from a variety of sources, and some useful polymers include: 5A97, available from Dow Chemical and having a melt flow of 12.0 g/10 min and a density of 0.90 g/cm³; DX5E66, also available from Dow Chemical and having an MFI of 8.8 g/10 min and a density of 0.90 g/cm³; and WRD5-1057 from Dow Chemical having an MFI of 3.9 g/10 min and a density of 0.90 g/cm³. Useful commercial propylene homopolymers are also available from Fina and Montel.

Examples of useful polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 ml/10 min and an elongation at break (ASTM D638) of 15. Grivory CF65 is a nylon 6/12 film grade resin having a melting point of 135° C., a melt flow index of 50 ml/10 min, and an elongation at break in excess of 350%. Grilon CR9 is another nylon 6/12 film grade resin having a melting point of 200° C., a melt flow index of 200 ml/ 10 min, and an elongation at break at 250%. Grilon XE 3303 is a nylon 6.6/6.10 film grade resin having a melting point of 200° C., a melt flow index of 60 ml/ 10 min, and an elongation at break of 100%. Other useful polyamide resins include those commercially available from, for example, International Paper of Wayne, N.J. under the Uni-Rez product line, and dimer-based polyamide resins available from Bostik, International Paper, Fuller, Henkel (under the Versamid product line). Other suitable polyamides include those produced by condensing dimerized vegetable acids with hexamethylene diamine. Examples of polyamides available from International Paper include Uni-Rez 2665; Uni-Rez 2620; Uni-Rez 2623; and Uni-Rez 2695.

Polystyrenes can also be utilized as the polymer facestock material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillips Petroleum Co. KR-10 is believed to be a copolymer of styrene with 1,3-butadiene.

Polyurethanes also can be utilized as the polymer film material, and the polyurethanes may include aliphatic as well as aromatic polyurethanes.

The polyurethanes are typically the reaction products of (A) a polyisocyanate having at least two isocyanate (--NCO) functionalities per molecule with (B) at least one isocyanate reactive group such as a polyol having at least two hydroxy groups or an amine. Suitable polyisocyanates include diisocyanate monomers, and oligomers.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of commercial polyurethanes include Sancure 27107 and/or Avalure UR 4457 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 8787, Sancure 8157, Sancure 13017, Sancure 27157, Sancure 18287, Sancure 20267, and Sancure 124717 (all of which are commercially available from Noveon, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia), and NeoRez R-960 (Avecia).

Examples of such aliphatic polyether polyurethanes include Sancure 27107 and/or Avalure UR 4457, Sancure 8787, NeoRez R-600, NeoRez R-966, NeoRez R-967, and Witcobond W-320.

In one embodiment, the facestocks comprises at least one polyester polyurethane. Examples of these urethanes include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company Avecia, and the acrylic copolymer dispersion sold under the name “Neocryl XK-90” by the company Avecia.

Polyesters prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307, which is polyethylene terephthalate.

Acrylate polymers and copolymers and alkylene vinyl acetate resins (e.g., EVA polymers) also are useful as the film forming materials in the preparation of the constructions of the invention. Commercial examples of available polymers include Escorene UL-7520 (Exxon), a copolymer of ethylene with 19.3% vinyl acetate; Nucrell 699 (duPont), an ethylene copolymer containing 11% of methacrylic acid, etc.

Ionomers (polyolefins containing ionic bonding of molecular chains) also are useful. Examples of ionomers include ionomeric ethylene copolymers such as Surlyn 1706 (duPont) which is believed to contain interchain ionic bonds based on a zinc salt of ethylene methacrylic acid copolymer. Surlyn 1702 from duPont also is a useful ionomer.

Polycarbonates also are useful, and these are available from the Dow Chemical Co. (Calibre) G.E. Plastics (Lexan) and Bayer (Makrolon). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

In one embodiment, the facestock polymer material may comprise fluorinated polymer. The fluorinated polymer includes a thermoplastic fluorocarbon such as polyvinylidene fluoride (PVDF). The fluorinated polymer also can include copolymers and terpolymers of vinylidene fluoride. A useful thermoplastic fluorocarbon is the polyvinylidene fluoride known as Kynar, a trademark of Pennwalt Corp. This polymer is a high molecular weight (400,000) polymer that provides a useful blend of durability and chemical resistance properties. Generally, a high molecular weight PVDF resin, with a weight average molecular weight of about 200,000 to about 600,000 is used.

The polymer facestock material is chosen to provide a continuous polymer film in the film structures of this invention with the desired properties such as improved tensile strength, elongation, impact strength, tear resistance, and optics (haze and gloss). The choice of polymeric facestock forming material also is determined by its physical properties such as melt viscosity, high speed tensile strength, percent elongation etc.

The thickness of the polymer facestock is from about 0.1 to about 10 mils, or from about 1 to about 5 mils. In one embodiment the thickness of the facestock is from about 1 to about 3 mils. The facestock may comprise a single layer, or the film can be a multilayer film of two or more adjacent layers. For example the film can comprise one layer of a polyolefin and one layer of a blend of a polyolefin and a copolymer of ethylene and vinyl acetate (EVA). In another embodiment the film comprises three layers, a base or core layer of, for example, a polyolefin, and skin layers in both sides of the base or core layer which may be comprised of the same or different polymer blends. The individual layers of a multilayer facestock may be selected to provide desirable properties.

The monolayer and multilayer film facestocks useful in the labels useful herein can be manufactured by those processes known to those skilled in the art such as by casting or extrusion. In one embodiment, the films are manufactured by polymer extrusion or coextrusion processes. The extrudate or coextrudate of polymeric film materials is formed by simultaneous extrusion from a suitable known type of extrusion or co-extrusion die, and in the case of a coextrudate, the layers are adhered to each other in a permanently combined state to provide a unitary coextrudate.

In addition to coextrusion, the multilayer film facestocks useful in the present invention may be prepared by extrusion of a continuous film to form one layer followed by the application of one or more additional layers on the extruded layer by extrusion of one or more additional layers; by lamination of a preformed polymer film to a preformed functional film; or by deposition of additional layers on the preformed film from an emulsion or solution of a polymeric film forming material.

In one embodiment, the facestocks used in the present invention are not oriented. That is, the facestock and films are not subjected to a hot-stretching and annealing step. In other embodiments, the facestock contained in the labels used in the present invention may be oriented in the machine direction (uniaxially) or in both the machine and cross directions (biaxially) by hot-stretching and annealing by techniques well known to those skilled in the art. For example, the films may be hot-stretched in the machine direction only at a ratio of at least 2:1 and more often, at a ratio of between about 2:1 to about 9:1. After the film has been hot stretched, it is generally passed over annealing rolls where the film is annealed or heat-set at temperatures in the range of from about 50° C., more often 100° C. to about 150° C., followed by cooling. In another embodiment, the facestock is a biaxially oriented.

It is desirable that the films exhibit a degree of stiffness in the machine direction and the cross direction to facilitate handling, printing and dispensing. Thus, in one embodiment, the stiffness in the machine direction, and the cross direction should be at least about 14 Gurley (mg), as determined using TAPPI Test T543 pm and in a further embodiment the Gurley stiffnesses in both directions are within about 5 Gurley units (sometimes referred to as a balanced stiffness).

The surface energy of both surfaces of the facestock can be enhanced by treatments such as corona discharge, flame, plasma, etc. to provide the surfaces with desirable properties such as improved adhesion to subsequently applied layers. Procedures for corona treating and flame treating of polymer films are well known to those skilled in the art. In one embodiment, a facestock is corona discharge treated on the upper surface and flame treated on the lower surface.

The activating layer (106, 206) comprises at least one activating agent for activating the release of the latent peroxide and the reaction between the oxalate and the peroxide initiator. Activating agents typically comprise at least one transition metal. Any transition metal compound can be used provided that the compound exhibits reactivity as an activator. The transition metals are those metals that have their valence electrons in a “d” subshell. Included in this group are the metals of Groups 3, 4, 5, 6, 7, 8, 9, 10 and 11 of the Periodic Table of Elements. Particularly useful transition metals include copper, chromium, manganese, iron, cobalt, nickel, and molybdenum. Alloys of these transition metals with minor amounts of other metals also can be utilized. For example, RotoStar 801-103 pigment, a bronze pigment based on 90% copper and 10% zinc is useful as an activating agent. RotoStar 801-103 pigment is available from Eckart America and contains a UV curable monomer.

The transition metal compound may be in the form of an inorganic or organometallic compound, including oxides, salts, and organometallic chelates and complexes. Suitable organic salts include the sulfates, nitrates, chlorides, bromides, phosphates and sulfides. Suitable organic salts include the alkoxides, for example, the methoxides and ethoxides, as well as the carboxylates, including the acetates, hexoates, octoates, ethylhexanoates, and naphthenlates. Other suitable transition metal complexes include the acetylacetonates and the hexafluoroacetylacetonates. Particularly useful transition metal compounds include copper 2-ethylhexanoate, copper acetate, copper naphthenate, copper octoate, copper hexoate, and copper hexafluoroacetylacetonate. The concentration of activating agent in the activating layer depends on the composition and thickness of the chemiluminescent layer used and should be sufficient to result in the generation of light from the chemiluminescent layer.

The activator can be an organocopper catalyst, such as LOCTITE 7469 PRIMER, which is commercially available from Henkel Loctite Corp. In other embodiments, suitable alternative activators include organo-iron compounds, zirconium complexes (such as K-KAT XC-923), metal chelates (such as NACURE XC-9206), and antimony-based catalysts (such as NACURE XC-7231), all of which are commercially available from King Industries, Inc. Yet other suitable activators in alternative embodiments include nitrogen and sulfur based activators.

In one embodiment, the transition metal activator is incorporated into a coating composition that is coated onto the lower surface of the facestock to form an activating layer. The activating layer can comprise a binder and an activating agent. The activating layer can be prepared from a mixture of a binder and the activating agent, generally in a diluent or solvent for the binder. The amount of activating agent mixed with and incorporated into the binder may vary over a wide range.

The binder that may be utilized in the activating layer may be any film forming monomer, oligomer or polymer or combinations thereof. The binders may be water soluble, organic solvent soluble, or insoluble in water and organic solvents since the coating compositions may be applied as solutions, dispersions or emulsions. Non-limiting examples of useful binders include polyurethanes, polyolefins, polyacryls, polymethacryls, polyamides, polyvinyl acetates, polyvinyl alcohols, polyvinyl ethers, polyacrylonitriles, polystyrenes, polyvinyl pyrrolidones, polyvinyl chlorides, poly(alkylene oxides), proteins, cellulosic polymers, gelatine, and copolymers of one or more monomers including olefins, (meth)acrylates, vinyl acetates, allyl acetates, vinyl chlorides, acrylonitriles, N-vinyl pyrrolidones, N-vinyl oxazolidones, vinyl ethers and other allylic and vinylic monomers.

The binder may also include an ethylenically unsaturated oligomer. Suitable ethylenically unsaturated oligomers include polyether urethane acrylate oligomers (e.g., CN986 available from Sartomer Company, Inc., (West Chester, Pa.)) and BR344, BR3731 and STC3-149 available from Bomar Specialties Co. (Winsted, Conn.)), acrylate oligomers based on tris(hydroxyethyl)isocyanurate, (available from Sartomer Company, Inc.), (meth)acrylated acrylic oligomers, (available from Cognis (Ambler, Pa.), polyester urethane acrylate oligomers (e.g., CN966 and CN973 available from Sartomer Company, Inc. and BR7432 available from Bomar Specialty Co.), polyurea urethane acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., all of which are hereby incorporated by reference), polyether acrylate oligomers (e.g., Genomer 3456 available from Rahn A G (Zurich, Switzerland), polyester acrylate oligomers (e.g., Ebecryl 80, 584, and 657 available from UCB Radcure (Atlanta, Ga.)), polyurea acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,1529,287 to Bishop et al., the specifications of which are hereby incorporated by reference), epoxy acrylate oligomers (e.g., CN120 available from Sartomer Company, Inc., and Ebecryl 3201 and 3604 available from UCB Radcure), hydrogenated polybutadiene oligomers (e.g., Echo Resin MBNX available from Echo Resins and Laboratory (Versailles, Mo.)), and combinations thereof.

In one embodiment, the binder includes at least one polyfunctional ethylenically unsaturated monomer. Suitable polyfunctional ethylenically unsaturated monomers include, without limitation, alkoxylated bisphenol A diacrylates such as ethoxylated bisphenol A diacrylate with ethoxylation being 2 or greater, preferably ranging from 2 to about 30 (e.g. SR349 and SR601 available from Sartomer Company, Inc. West Chester, Pa. and Photomer 4025 and Photomer 4028, available from Cognis Corp. (Ambler, Pa.)), and propoxylated bisphenol A diacrylate with propoxylation being 2 or greater, preferably ranging from 2 to about 30; propoxylated neopentyl glycol diacrylate (e.g., SR9003, Sartomer Company, Inc.); methylolpropane polyacrylates with and without alkoxylation such as ethoxylated trimethylolpropane triacrylate with ethoxylation being 3 or greater, preferably ranging from 3 to about 30 (e.g., Photomer 4149, Cognis Corp., and SR499, Sartomer Company, Inc.), propoxylated trimethylolpropane triacrylate with propoxylation being 3 or greater, preferably ranging from 3 to 30 (e.g., Photomer 4072, Cognis Corp. and SR492, Sartomer), and ditrimethylolpropane tetraacrylate (e.g., Photomer 4355, Cognis Corp.); alkoxylated glyceryl triacrylates such as propoxylated glyceryl triacrylate with propoxylation being 3 or greater (e.g., Photomer 4096, Cognis Corp. and SR9020, Sartomer); erythritol polyacrylates with and without alkoxylation, such as pentaerythritol tetraacrylate (e.g., SR295, available from Sartomer Company, Inc. (West Chester, Pa.)), ethoxylated pentaerythritol tetraacrylate (e.g., SR494, Sartomer Company, Inc.), and dipentaerythritol pentaacrylate (e.g., Photomer 4399, Cognis Corp., and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.) and ethoxylated polyethylene glycol diacrylate with ethoxylation being 2 or greater, preferably ranging from about 2 to 30; epoxy acrylates formed by adding acrylate to bisphenol A diglycidylether and the like (e.g., Photomer 3016, Cognis Corp.); and single and multi-ring cyclic aromatic or non-aromatic polyacrylates such as dicyclopentadiene diacrylate and (dicyclopentane diacrylate.

The activator layer coating composition may also contain a polymerization initiator that is suitable to cause polymerization (i.e., curing) of the binder composition after its application to the facestock. For ultraviolet radiation curing, the initiator includes at least one photoinitiator. Suitable photoinitiators include 1-hydroxycyclohexylphenyl ketone (e.g., Irgacure 184 available from Ciba Specialty Chemical (Hawthorne, N.Y.), (2,6-dimethoxybenzoyl)-2,4,4-trimethylpentyl phosphine oxide (e.g., commercial blends Irgacure 1800, 1850, and 1700 available from Ciba Specialty Chemical), 2,2i-dimethoxyl-2-phenyl acetophenone (e.g., Irgacure 651, available from Ciba Specialty Chemical), bis(2,4,6-trimethyl benzoyl)phenyl-phosphine oxide (Irgacure 819), (2,4,6-trimethylbenzoyl)diphenyl phosphine oxide (Lucerin TPO, available from BASF (Munich, Germany)), ethoxy (2,4,6-trimethylbenzoyl)phenyl phosphine oxide (Lucerin TPO-L from BASF), and combinations thereof. A particularly useful photoinitator is Irgacure 500, commercially available from Ciba Specialty Chemical, which is a 1:1 blend of Irgacure 184 and benzophenone.

In one embodiment, the activating layer may comprise an adhesive layer containing at least one activating compound. Useful adhesive include those described above as useful for the chemiluminescent layer. The activating layer may also comprise a gel layer.

The activating layer can be formed on the facestock or release liner in various manners, for instance by means of engraving coating (e.g., direct gravure, reverse gravure, etc.), slot die, off-set coating, roll coating, curtain coating, or a casting process. The choice for a certain production method depends on the raw material characteristics and the desired thickness of the activating layer.

Drying of a water or diluent based system can be done by the usual thermal drying techniques, by means of microwaves or by infrared drying. Solvent-less systems can be cured thermally, by means of UV curing or Electron Beam curing.

Alternatively, the activating layer can be extruded onto the polymer facestock. In yet another embodiment, the facestock and the activating layers can be formed by coextrusion. In a further embodiment, the activating layer can be formed by sputtering or depositing a transition metal onto a surface of the facestock. For example, a copper sputtered transparent solar control film such as available from CP Films Inc. of Martinsville, Va. under the designation 15396A may be used in the labels of the invention where the copper is the activating agent.

The release liner 108 that can be used in the construction of the embodiments, illustrated in FIGS. 1a and 2a, may consist of any single- or two-sided release. That is, one or both surfaces of the release liner are low surface energy surfaces.

The chemiluminescent article may include additional layers within the construction. For example, the article may further comprise a print layer overlying or underlying the facestock layer. The article may further comprise a layer to control or alter the light emitted from the chemiluminescent layer. Such layers include, for example, a light-focusing layer, a light-diffusing layer, a light-polarizing layer, a reflective layer, a retroreflective layer, a prismatic layer, combinations of two or more of these layers, etc.

While the invention has been explained in relation to its various embodiments, it is to be understood that various modifications thereof will become apparent to those skilled in the art upon reading the specification. Therefore, it is to be understood that the invention disclosed herein is intended to cover such modifications as fall within the scope of the appended claims.

1. A chemiluminescent article comprising:
a transparent facestock layer having an inner surface and an outer surface;
a chemiluminescent layer comprising at least one chemiluminescent compound and a latent initiator, wherein the inner surface of the facestock layer overlies the chemiluminescent layer; and
an activator layer comprising at least one activating compound operable to react with the latent initiator whereby the initiator causes the chemiluminescent compound to emit light.

2. The article of claim 1 wherein the chemiluminescent layer comprises an adhesive layer.

3. The article of claim 1 wherein the chemiluminescent layer comprises a gel layer.

4. The article of claim 2 wherein the adhesive comprises a pressure sensitive adhesive.

5. The article of claim 1 wherein the latent initiator comprises a latent oxidizer.

6. The article of claim 5 wherein the oxidizer comprises hydrogen peroxide.

7. The article of claim 1 wherein the chemiluminescent layer further comprises at least one fluorescer.

8. The article of claim 1 wherein the chemiluminescent compound comprises an oxalate.

9. The article of claim 1 wherein the activator compound comprises at least one of a transition metal, a transition metal ion, a transition metal compound and a transition metal complex.

10. The article of claim 1 wherein the activator layer comprises an adhesive layer.

11. The article of claim 1 wherein the activator layer comprises a gel layer.

12. The article of claim 1 wherein the activator layer further comprises a binder.

13. The article of claim 9 wherein the transition metal comprises copper.

14. The article of claim 1 wherein the facestock layer comprises a first portion and a second portion on its inner surface and wherein the chemiluminescent layer overlies the chemiluminescent layer and the second portion overlies the activator layer.

15. The article of claim 14 wherein the facestock layer is capable of being folded onto itself to bring the activator layer into contact with the chemiluminescent layer.

16. The article of claim 14 further comprising a release liner releasably adhered to the chemiluminescent layer and the activator layer.

17. The article of claim 1 further comprising a release liner having first release surface and a second surface, wherein the release surface is releasably adhered to the chemiluminescent layer and the activator layer is adhered to the second surface.

18. The article of claim 17 wherein the release layer is removable from the chemiluminescent layer and repositionable to bring the activator layer adhered to the second surface into contact with the chemiluminesent layer.

19. The article of claim 1 further comprising a print layer.

20. The article of claim 1 further comprising a light-focusing layer.

21. The article of claim 1 further comprising a light-diffusing layer.

22. The article of claim 1 further comprising a light polarizing layer.

23. The article of claim 1 further comprising a reflective layer.

24. The article of claim 1 further comprising a retroreflective layer.

25. The article of claim 1 further comprising a prismatic layer.

26. The article of claim 1 wherein the article comprises a label.

27. The article of claim 1 wherein the article comprises a tape.

28. A chemiluminescent article comprising a transparent facestock layer having an inner surface and an outer surface;
a chemiluminescent layer comprising an adhesive layer comprising at least one chemiluminescent compound, wherein the inner surface of the facestock layer overlies the chemiluminescent layer; and
an activator layer comprising at least one activating compound operable to react with chemiluminescent compound to emit light.

29. The article of claim 28 wherein the activating compound comprises an oxidizer.

30. The article of claim 28 wherein the facestock layer comprises a first portion and a second portion on its inner surface and wherein the chemiluminescent layer overlies the chemiluminescent layer and the second portion overlies the activator layer.

31. The article of claim 30 wherein the facestock layer is capable of being folded onto itself to bring the activator layer into contact with the chemiluminescent layer.

32. The article of claim 30 further comprising a release liner releasably adhered to the chemiluminescent layer and the activator layer.

33. The article of claim 28 further comprising a release liner having first release surface and a second surface, wherein the release surface is releasably adhered to the chemiluminescent layer and the activator layer is adhered to the second surface.

34. The article of claim 33 wherein the release layer is removable from the chemiluminescent layer and repositionable to bring the activator layer adhered to the second surface into contact with the chemiluminesent layer.
